(19) United States
(12) Patent Application Publication
(10) Pub. No.: US 2014/0166662 A1
(43) Pub. Date: Jun. 19, 2014

(54) Suspension System for a Cryogenic Vessel

(71) Applicant: HEBELER CORPORATION, Tonawanda, NY (US)

(72) Inventors: Kenneth Leo Snyder, Hamburg, NY (US); James Joseph Donovan, Tonawanda, NY (US); Robert Francis Desjardins, Boston, NY (US); Nathaniel Eaton Allen, Buffalo, NY (US); Mark Ray Nuernberger, West Falls, NY (US)

(73) Assignee: Hebeler Corporation, Tonawanda, NY (US)

(21) Appl. No.: 13/713,798

(22) Filed: Dec. 13, 2012

(51) Int. Cl. F17C 13/00

(52) U.S. Cl. CPC F17C 13/00
USPC 220/560.1

(57) ABSTRACT

A double walled vacuum insulated cryogenic vessel including a support system for the inner vessel that comprises an inner vessel support, a support bushing, and an outer vessel support. The inner vessel support is affixed to the inner vessel and the outer vessel support is affixed to the outer vessel. Between the two supports is a support bushing which is not affixed to the inner vessel support, the outer vessel support, the inner vessel, nor the outer vessel. Anti-rotational support is provided either by mechanical means, shapes, or secondary support structures.

### BACKGROUND OF THE INVENTION

This disclosure relates generally to a container and delivery system for cryogens. More particularly, this disclosure relates to a vehicle mounted system for storing a cryogenic and supplying the cryogen to the engine of the vehicle. The present disclosure is particularly adapted for, but not limited to, a vehicle-mounted tank for efficiently holding liquefied natural gas (LNG).

Over the past several decades, LNG has been explored as a fuel alternative for motor vehicles. Until recently, LNG was an economically unviable fuel option, as LNG cost more than diesel or gasoline fuel. However, with the discovery of large gas reserves domestically and abroad, the price of LNG has fallen to a level where it may be competitive with conventional motor fuels. With domestic natural gas reserves sufficient to meet demand for the foreseeable future, utilizing LNG as a vehicular fuel may help curb our reliance on foreign fuel sources. In addition, as natural gas burns more cleanly than either diesel or gasoline, utilizing LNG as a fuel source should serve to reduce vehicular pollution.

In the present disclosure, LNG is the preferred example of a cryogen because of the vast reserves of natural gas, the affordability of natural gas, and the expanding infrastructure for natural gas. However, people skilled in the technology would understand that the present disclosure can be employed to hold other cryogens.

For the purpose of this application, cryogenic liquids include liquefied gas that boil at or below −150° F. under normal atmospheric pressure. LNG is one example of a cryogenic liquid because it boils at −258° F. under normal atmospheric pressure. Because of the low temperatures required to keep the cryogen in its liquid state, most cryogenic tanks are of a double wall construction, which is done to improve the thermal performance of the tank. The inner vessel, which may be a pressure vessel, is typically supported within the outer vessel. Radiation shielding is usually placed in the space between the inner and outer vessels, and the space between the inner and outer vessels is then placed under a high order vacuum to provide particularly effective insulation.

While double walled cryogenic tanks are able to insulate the inner vessel to some degree, any structural supports for the inner vessel, as well as piping between the inner vessel and outside environment provide heat conduction paths which transfer heat from outside the tank to the cryogen in the tank. This is typically referred to as “heat leak.” Heat leak is a concern because as the cryogen heats up it reverts to a gaseous state and expands, thereby increasing the pressure within the inner vessel. Once the pressure in the inner vessel becomes too high, a pressure relief valve will open, releasing a portion of the tank's contents into the atmosphere or to a recovery system. “Holding time” describes the time span that a cryogen can be held inside the storage container before the pressure relief valve opens.

In certain large cryogenic tanks, heat leak from the piping between the inner vessel and outside environment, as well as from the suspension system for the inner tank, is not a major concern because, relative to the amount of fuel stored in the container, the amount of heat entering the tank is marginal. However, for smaller tanks the heat leak from the suspension system, as well as the piping between the inner vessel and the outside environment, is a major concern, as the amount of heat entering the tanks is much greater relative to the amount of cryogen stored in the tank. Because high heat leak leads to shorter holding times, heat leak in a small tank will result in the small tank venting off a substantial portion of the cryogen if the tank is required to hold the cryogen for any appreciable amount of time. For example, if a cryogenic tank is affixed to a vehicle and used to store LNG as fuel for use in that vehicle, any gas that is vented off because of heat leak is fuel that was paid for by the operator but never used, creating a cost. While it is impossible, with presently available technologies, to completely eliminate heat leak attributable to the suspension system of the inner vessel, tank manufacturers have taken steps to try and minimize this source of heat leak.

Presently, tank manufacturers use a variety of means to suspend the inner vessel within the outer vessel. Some cryogenic tanks utilize a “central beam” design, where a beam runs from one end of the outer vessel, through the inner vessel, and connects at the other end of the outer vessel. Within the center beam is an apparatus where the cryogen can be extracted from within the inner vessel, exiting both the inner and outer vessel through the central beam. This suspension system, while providing only two points of contact where heat can enter the inner vessel, is not ideal because the beam occupies space that could otherwise be used to store the cryogen. In addition, because the beam travels through the center of the inner vessel, it may be possible for heat to travel down the beam, from the ends of the outer vessel toward the center of the inner vessel, heating the cryogen as it travels, thus generating heat leak.

Other cryogenic tanks utilize a support system whereby non metallic, tubular supports penetrate both the outer walls of the outer vessel and the inner walls of the inner vessel. Typically the cryogen is drawn from the inner vessel through one of the tubular supports, which acts as a conduit, while the other tubular support serves only to suspend the inner vessel within the outer vessel. Similar to the center beam suspension system, the tubular suspension system also has two points where heat leak may occur, namely where the suspension system is in contact with the outer tank. When compared to a tank utilizing a center beam, a tank utilizing a tubular suspension system is able hold more of the cryogen because there is no center beam taking up space in the inner vessel. However, the tubular support suspension system creates a different problem. Because the tubular support is in direct contact with both the inner and outer vessels, there is a direct path for heat to leak into the inner vessel, which may reduce holding time and thus inhibit tank performance.

Both the center beam and the tubular support suspension systems limit the sources of heat leak, as there are only two points where heat can enter the inner vessel; the two points where the suspension systems are in contact with the outer vessel. An additional advantage to using either a center beam or a conduit is that they provide anti-rotation support for the inner vessel. However, tanks with a center beam are unable to hold as much of the cryogen as comparable tanks designed without a center beam, and tanks with tubular supports may allow more heat leak into the inner vessel which in turn reduces holding times.

Other tanks have managed to limit heat leak caused by intrusions into the inner vessel by utilizing suspension methods that do not intrude into the inner vessel. Rather, the inner vessel is suspended within the outer tank by high tensile strength wires which are strung from the ends of the inner vessel to the inside of the outer shell. Unlike the center beam and the tubular support systems, the wire suspension system limits heat leak into the tank because the wire suspension system does not intrude into the inner vessel. However, each wire in a wire suspension system serves as a medium for heat to travel to the inner tank. Additionally, wire suspension systems make manufacturing significantly more difficult.

In a further suspension system, other tank designs suspend an inner vessel within an outer vessel by using support membranes that serve as a buffer between the inner vessel and the outer vessel. While these support membrane designs do not intrude into the inner vessel as the center beam or conduits do, they still allow a path for heat to travel to the inner vessel. The support membrane is in direct contact with both the inner and outer vessels at multiple points, often supporting the weight of the inner vessel within the outer vessel. As such, heat has an avenue to travel from the outer vessel, through the support membrane, to the inner vessel, which induces heat into the inner vessel.

In existing cryogenic tank designs, the suspension systems account for much of the heat leak into the inner vessel. Because heat leak reduces a cryogenic tanks holding time, a suspension system that reduces the amount of heat leak into a cryogenic tank will deliver longer standby times. It is an advantage of the present disclosure that the suspension system does not extend into or through the inner vessel, thus not inducing heat into the inner vessel. It is an additional advantage of the present disclosure that the suspension system has only two points of contact between the inner and outer vessels, thus limiting the sources where heat leak into the inner vessel can occur.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE INVENTION

The present disclosure overcomes the above-noted shortcomings and provides a new construction for a multi-layered vacuum insulated cryogenic tank. The construction suspends an inner vessel within the outer vessel without intruding into the inner vessel or extending beyond the outer vessel. Further, the present disclosure provides only two points of contact between the inner vessel and the outer vessel. The construction allows for cylindrical and non-cylindrical shapes to be used for the inner and outer vessels.

The present disclosure includes a cryogenic tank whereby an inner vessel, which may be pressurized, is fully suspended within an outer vessel by two or more supports. The area between the inner and outer vessels is evacuated and may contain insulating material. The inner vessel is suspended within the outer vessel by using one or more supports which are attached to the outer surface of the inner vessel, and which do not protrude into the inner vessel. The outer vessel has a similar support which is attached to the inner surface of the outer vessel, and which does not protrude beyond the outer vessel. The outer vessel supports and inner vessel supports are of different sizes. Between the inner vessel supports and the outer vessel supports is an insulated support bushing. The bushing may be longer than the supports affixed to both the inner and outer tanks. The present disclosure also includes an anti-rotation device to prevent the inner vessel from rotating within the outer vessel.

### BRIEF DESCRIPTION OF THE SEVERAL VIEWS OF THE DRAWING

FIG. 1. is a simplified view of a cryogenic vessel utilizing the support system of the disclosure.

FIG. 2. is a sectional view showing one end of a cryogenic vessel utilizing the support system of the disclosure.

FIG. 3. is a sectional view showing one end of a cryogenic vessel utilizing the support system of the disclosure.

FIG. 4. is a rotated partially exploded sectional of an embodiment of the disclosure on a cryogenic vessel.

FIG. 5. is an exploded sectional view of a cryogenic vessel utilizing an embodiment of the disclosure with a means of providing anti-rotation support.

FIG. 6. is an exploded sectional view of a cryogenic vessel utilizing an embodiment of the disclosure with a means of providing anti-rotation support.

FIG. 7. is a simplified view of a cryogenic vessel utilizing the support system of the disclosure with a means of providing anti-rotation support.

FIG. 8. is a simplified view of a cryogenic vessel utilizing the support system of the disclosure with a means of providing anti-rotation support.

FIG. 9 is a sectional view showing one end of a cryogenic vessel utilizing the support system of the disclosure

### DETAILED DESCRIPTION OF THE PREFERRED EMBODIMENT

The following description is of the preferred embodiment and is merely exemplary in nature. In no way is the following description intended to limit the disclosure, its application, or its uses.

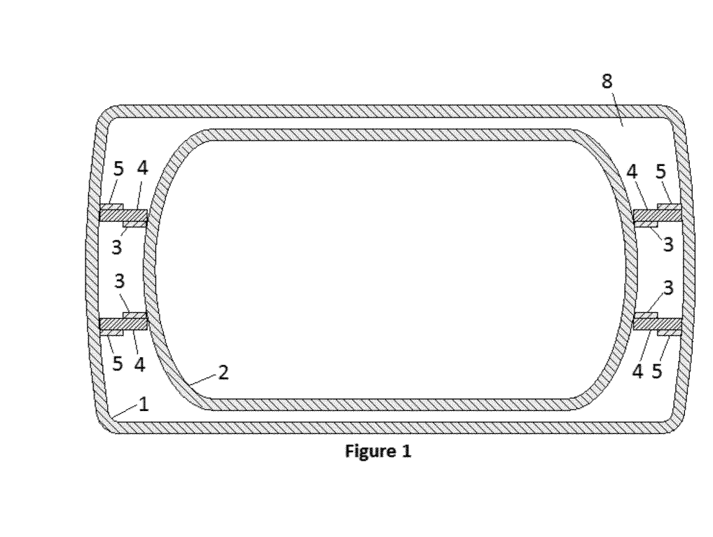

FIG. 1 shows a preferred embodiment of a cryogenic storage tank utilizing the support system of the disclosure. The cryogenic storage tank has an inner vessel 2 that is used to store a quantity of a cryogen. The inner vessel 2 may be pressurized. The inner vessel 2 is suspended within an outer vessel 1, with the area between the two vessels 8 being evacuated by a high order vacuum in order to minimize the heat transfer from the external environment to the interior of the inner vessel 2. Additionally, the space between the inner 2 and outer 1 vessel 8 may contain insulating material to further minimize the heat transfer from the external environment to the interior of the inner vessel. The inner vessel 2 is suspended apart from the outer vessel 1 by a series of support mechanisms 3, 4, 5 located at opposite sides of the tank. The inner vessel 2 is not in direct contact with the outer vessel 1 at any point other than through the support mechanisms 3, 4, 5.

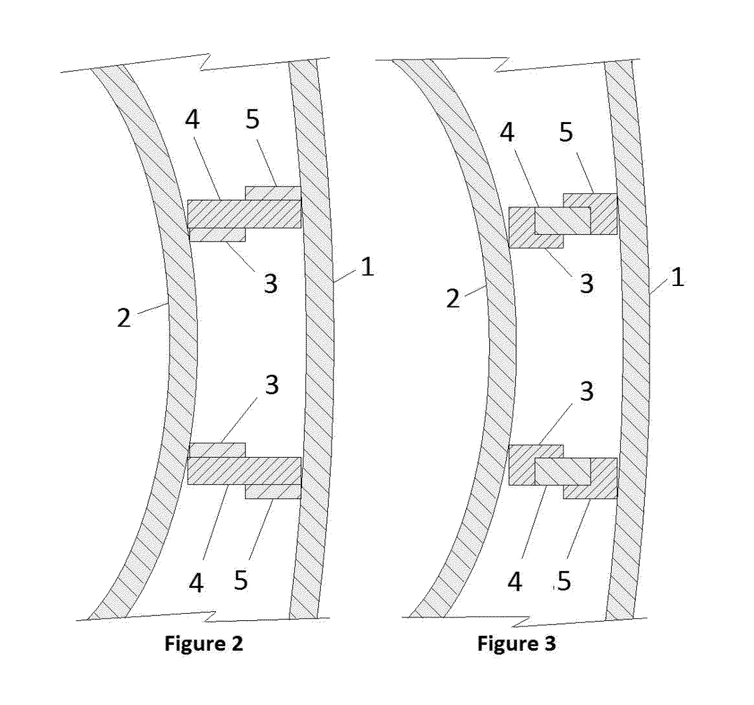

As illustrated in FIG. 2, affixed to the inner vessel 2 is an inner vessel support 3. The inner vessel support 3 may be affixed to the inner vessel 2 by any welded or mechanical means sufficient to support the inner vessel 2 when the inner vessel 2 is filled with a cryogen and under the stress of operation. The stress of operation may be higher in certain applications such as in motor vehicles, marine vessels, aerospace applications, and other similar environments. The inner vessel support 3 may be of any shape or size and may be made of any material sufficient to support the inner vessel 2.

A similar outer vessel support 5 is affixed to the outer vessel 1. This outer vessel support 5 may be affixed to the outer vessel 1 by any welded or mechanical means sufficient to support the inner vessel 2 when the inner vessel 2 is filled with a cryogen and under the stress of operation. The stress of operation may be higher in certain applications such as in motor vehicles, marine vessels, aerospace applications, and other similar environments. The outer vessel support 5 may be of any shape or size and may be made of any material sufficient to support the inner vessel 2.

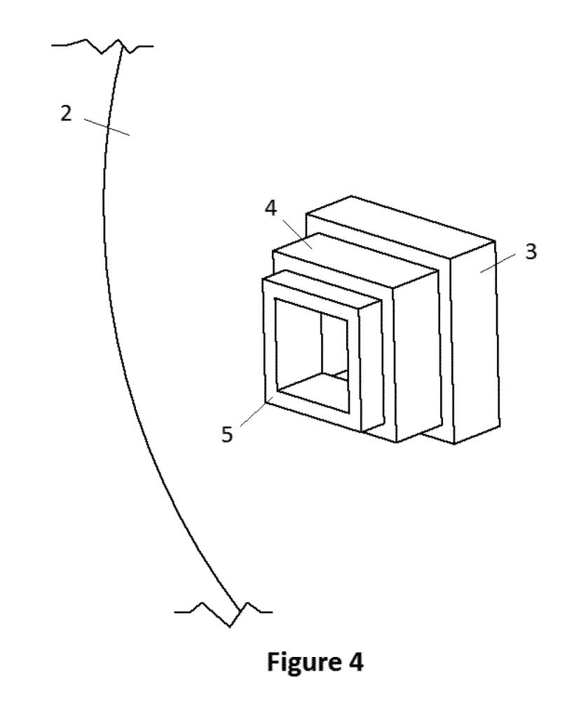

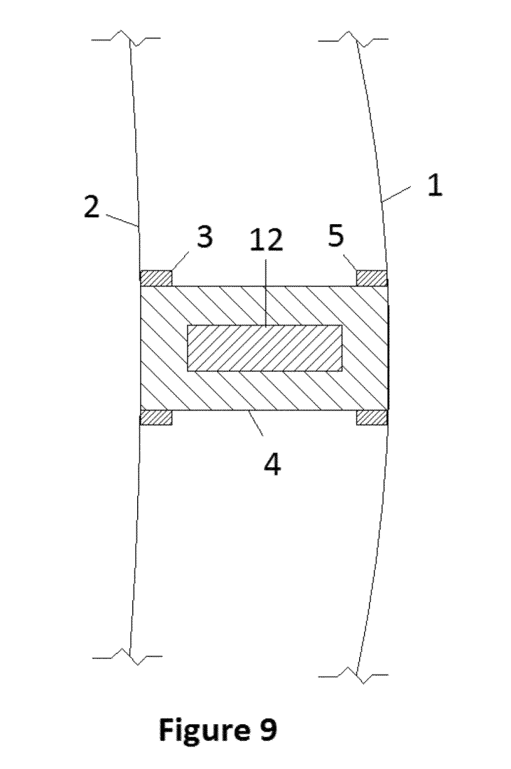

The inner vessel support 3 and the outer vessel support 5 may be of similar or different shapes and thicknesses. As seen in FIG. 9, the inner vessel support 3 and the outer vessel support 5 may be the same size, with a support bushing 4 fitting within and extending between both the inner vessel support 3 and outer vessel support 5. However, as can be seen in FIGS. 2-6, the inner vessel support 3 and the outer vessel support 5 may be of different sizes and are fitted together with a support bushing 4 interlaid between the inner vessel support 3 and the outer vessel support 5. In this embodiment, it is immaterial whether the inner vessel support 3 or the outer vessel support 5 is the larger or smaller of the two supports. In all embodiments, the inner vessel support 3, the support bushing 4, and the outer vessel support 5 shall fit securely together.

Between the inner vessel support 3 and outer vessel support 5 is a support bushing 4. The support bushing 4 is not affixed to the inner vessel 2, the inner vessel support 3, the outer vessel support 5, or the outer vessel 1. The support bushing 4 shall be of a sufficient length whereby the inner vessel support 3 shall not contact the outer vessel 1 and the outer vessel support 5 shall not contact the inner vessel 2, as illustrated in FIG. 2.

The support bushing 4 may be made of any material of sufficient strength to support the inner vessel 2 when the inner vessel 2 is filled with a cryogen and under the stress of operation. As seen in FIG. 9, the support bushing 4 may be a reinforced rigid body, similar to rebar in concrete. In FIG. 9, the support bushing 4 is reinforced with a high strength insert 12. The stress of operation may be higher in certain applications such as in motor vehicles, marine vessels, aerospace applications and similar environments. The support bushing 4 may be of any shape, size, or thickness so long as it fits securely within or between the inner vessel support 3 and the outer vessel support 5. The support bushing 4 may be a hollow or a solid element. The support bushing 4 shall be of a sufficient length to withstand the thermal contraction and expansion of the inner vessel 3 as it is expands and contracts due to the addition and removal of a cryogenic. In a preferred embodiment of the disclosure, the support bushing 4 shall be made of a high strength material possessing a low thermal conductivity, as a material with these qualities will inhibit heat leak into the inner vessel 2 through the suspension system 3, 4, 5.

In a preferred embodiment of the disclosure, as in FIG. 2, the support bushing 4 and the outer vessel support 5 are the only components of the suspension system 3, 4, 5 in contact with the outer vessel 1, while the support bushing 4 and the inner vessel support 3 are the only components of the suspension system 3, 4, 5 in contact with the inner vessel 2. Therefore, the only bridge for conductive heat to enter the inner vessel 2 from the outer vessel 1 is through the support bushing 4. As such, if the support bushing 4 is made of a material with a low thermal conductivity, the introduction of conductive heat into the inner vessel 2 through the suspension system 3, 4, 5 should be less in the present embodiment than in tanks utilizing conventional suspension systems. Further, by not protruding into the inner vessel 2, the suspension system 3, 4, 5 of the present embodiment has a smaller surface area whereby conductive heat can be transferred into the inner vessel 2 relative to tanks where the suspension system protrudes into the inner vessel 2.

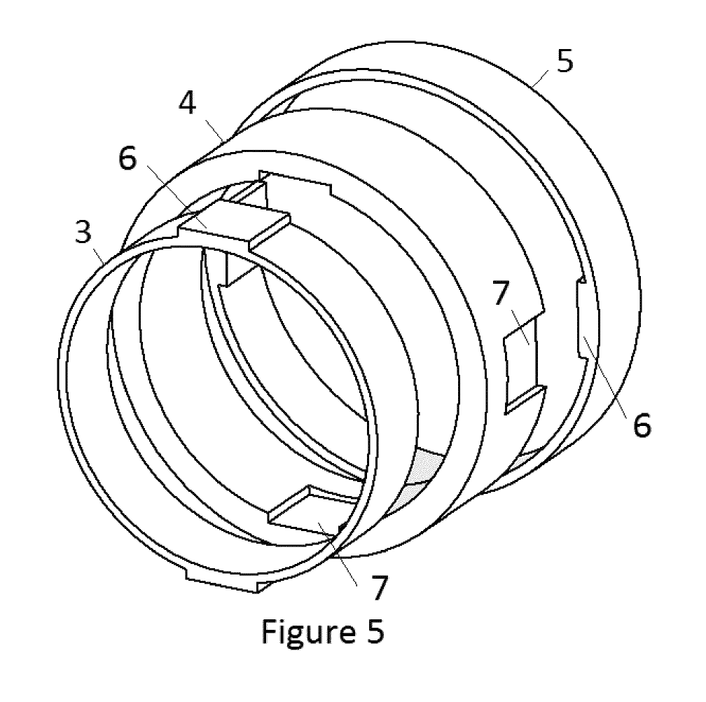

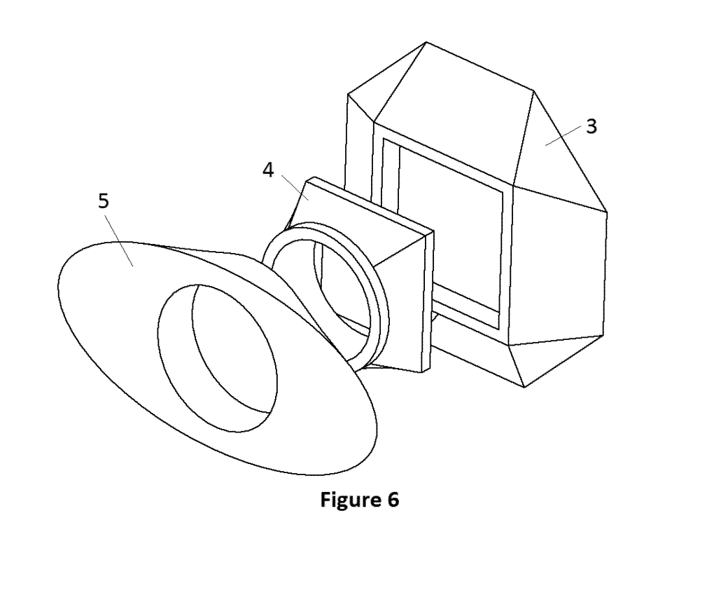

The inner vessel support 3 and the outer vessel support 5 can be made in any shape, so long as they fit together with the support bushing 4 either fitted within or interlaid between them. In FIG. 4, the inner vessel support 3, the support bushing 4, and outer vessel support 5 are all rhomboidal in shape. In FIG. 6, the inner vessel support 3, support bushing 4, and the outer_{.} vessel support 5 are all of different shapes and have been made to fit together. In an embodiment of the present disclosure, most clearly shown in FIGS. 4 and 5, if the shape of the inner vessel support 3, outer vessel support 5, and support bushing 4 are any shape other than a circular, no anti-rotational devices or supports are needed, as the edges of the supports, or any non-continuous curves, shall prevent the tank from rotating.

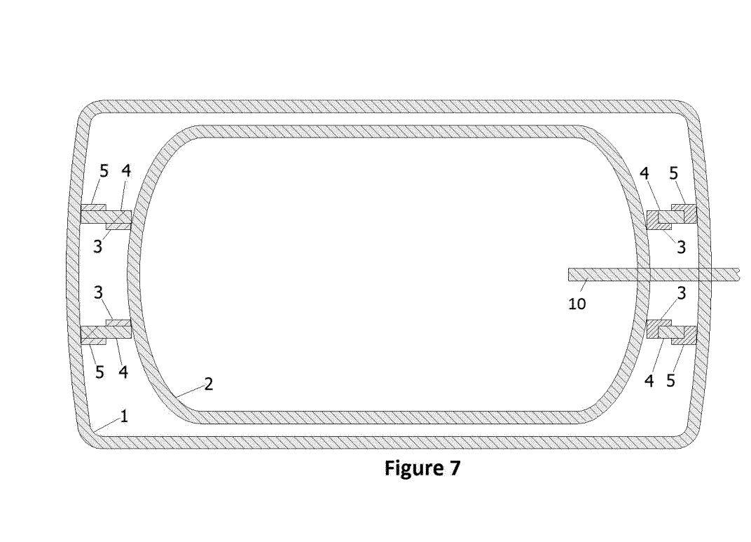

In a preferred embodiment, as seen in FIG. 5 the inner vessel, support 3, support bushing 4, and the outer vessel support 5, are circular. If the inner vessel support 3, support bushing 4, and the outer vessel support 5 are circular, an anti-rotational device may be needed to prevent the inner vessel 2 from rotating within the outer vessel 1. In an embodiment of the present disclosure, as seen in FIG. 7, anti-rotational support may be provided by any intrusion 10 into the inner vessel 2 that is used in connection with the input or extraction of a cryogen into or out of the inner vessel 2.

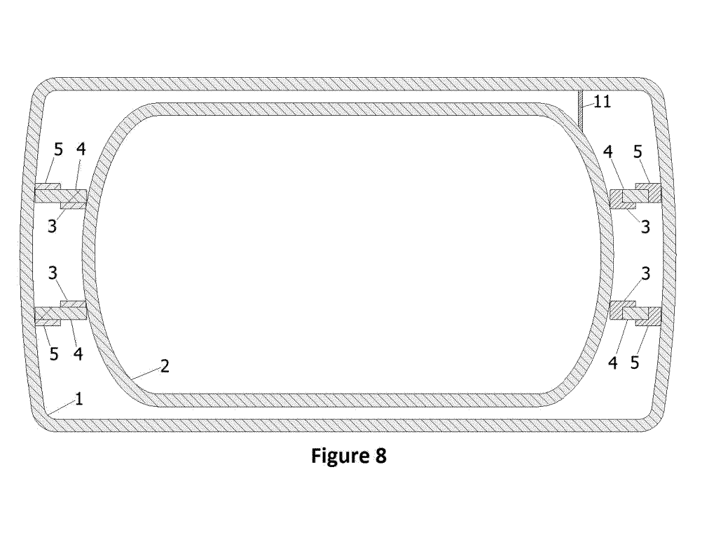

As another preferred embodiment, as seen in FIG. 8, when the inner vessel support 3, support bushing 4, and outer vessel support 5 are circular, anti-rotational support is provided by an object 11 that is affixed to the inner vessel 2 at one end, and either secured to the outer vessel 1 at the other end or secured at a point beyond the outer vessel.

As a further preferred embodiment, as seen in FIG. 5, when the inner vessel support 3, support bushing 4, and outer vessel support 5 are circular, anti-rotational support is provided by a mechanical method or shape, such as a key, pin, or flange. One such embodiment is shown in FIG. 5. In FIG. 5, the inner vessel support 3 and the outer vessel support 5, have key locks 6. The key locks 6 on the inner vessel support 3 and outer vessel support 5 have corresponding key ways 7 in the support bushing 4. When properly aligned, the key locks 6 and key ways 7 will fit together and provide anti-rotational support when the suspension system 3, 4, 5 is fitted together. When the inner vessel support 3, support bushing 4, and the outer vessel support 5 are circular, the anti-rotational method consisting of key locks 6 and key ways 7 shall be present on at least one end of the cryogenic vessel.

The present disclosure does not include any piping into or out of the inner vessel, used in conjunction with the input or extraction of the cryogen into or out of the inner vessel or otherwise, it being understood that any such piping may be utilized in conjunction with the present disclosure, such as to provide anti rotation support as seen in FIG. 7.

What is claimed is:

1. A cryogenic storage vessel comprising:
(a) a fluid tight inner vessel for storing a cryogenic liquid;
(b) an outer vessel fully surrounding the fluid tight inner vessel, the inner vessel being spaced apart from the outer vessel and the space between the inner vessel and outer vessel comprising an insulation space;
(c) a suspension system for holding the inner tank separate and apart from the outer vessel, the suspension system being located on opposite sides of the cryogenic storage vessel and consisting of an inner vessel support, a support bushing, and an outer vessel support.

2. The cryogenic storage vessel of claim 1 wherein the insulation space between the two vessels is filled with an insulating medium and is evacuated.

3. In the suspension system for the cryogenic storage vessel of claim 1 the inner vessel support is not in direct contact with the outer vessel and the outer vessel support is not in direct contact with the inner vessel.

4. In the suspension system for the cryogenic storage vessel of claim 1 the outer vessel support and inner vessel support are of any geometric configuration and are made of any high strength material.

5. In the suspension system for the cryogenic storage vessel of claim 1 the inner vessel support is affixed to the inner vessel by any welded or mechanical means sufficient to support the inner vessel when the inner vessel is filled with a cryogen and is under the stress of operation.

6. In the suspension system for the cryogenic storage vessel of claim 1 the outer vessel support is affixed to the outer vessel by any welded or mechanical means sufficient to support the inner vessel when the inner vessel is filled with a cryogen and is under the stress of operation.

7. The suspension system for the cryogenic storage vessel of claim 1 whereby the support bushing is fitted between the inner vessel support and the outer vessel support.

8. The suspension system for a cryogenic storage vessel of claim 1 whereby the support bushing is fitted within both the inner vessel support and the outer vessel support.

9. In the suspension system for the cryogenic storage vessel of claim 1 the support bushing is not affixed to the outer vessel, the inner vessel, the outer vessel support, nor the inner vessel support.

10. In the suspension system for the cryogenic storage vessel of claim 1 the support bushing is made of any material or combination of materials, of either a hollow design or of a solid element, of a strength sufficient to support the inner vessel when the inner vessel is filled with a cryogen and under the stress of operation.

11. The suspension system for the cryogenic storage tank of claim 1 where when the inner vessel support, the outer vessel support, and the support bushing are tubular in shape, anti-rotational support is provided by a protrusion into the inner vessel that is used to deliver, extract, or both deliver and extract the cryogen to or from the inner vessel.

12. The suspension system for the cryogenic storage vessel of claim 1 where when the inner vessel support, the outer vessel support, and the support bushing are tubular in shape, anti-rotational support is provided by a support affixed to the inner vessel at one end by any welded or mechanical means and affixed at the other end to the outer vessel by any welded or mechanical means.

13. The suspension system for the cryogenic storage vessel of claim 1 where when the inner vessel support, the outer vessel support, and the support bushing are tubular in shape, anti-rotational support is provided by a secondary support affixed to the inner vessel at one end by any welded or mechanical means and affixed at the other end to a structure beyond the outer vessel.

14. The suspension system for the cryogenic storage vessel of claim 1 where when the inner vessel support, the outer vessel support, and the support bushing are tubular in shape, anti-rotational support is provided by a mechanical method or shape, such as a key, a pin, or a flange.
